(19) United States
(12) Patent Application Publication
(10) Pub. No.: US 2010/0328215 A1
(43) Pub. Date: Dec. 30, 2010

(54) METHOD FOR OPERATING MOUSE WHEEL ACCORDING TO POSITION OF CURSOR POINTER

(76) Inventor: Kuo-Shu Cheng, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/495,217

(22) Filed: Jun. 30, 2009

(51) Int. Cl. G06F 3/033

(52) U.S. Cl. 345/163

(57) ABSTRACT

A method for operating a mouse wheel of a mouse of a computer according to a position of a cursor pointer of the mouse is provided. According to the method, a software is used to partition a screen frame or a software window frame into at least two sub-fields. Each of the sub-fields is corresponding to a predetermined related mouse wheel functional operation instruction. When a cursor pointer of the mouse is moved into one of the sub-fields, and while the mouse wheel is in operation, the predetermined related mouse wheel functional operation instruction corresponding to the sub-field in which the cursor pointer is instantly located is then initiated and executed.

### BACKGROUND OF THE INVENTION

1. Field of the Invention

The present invention relates generally to a method for operating a PC mouse wheel, and more particularly, to a method for switching operation functions of a PC mouse wheel, according to a sub-field of a screen frame or a software window frame in which a cursor pointer of the PC mouse is located.

2. The Prior Arts

Typically, in a normal PC operation, e.g., browsing a file, a picture, or a webpage, a mouse wheel can be forward or backward rolled for driving a vertical scroll bar to scroll the screen window up or down. However, when a breadth of the instant file, picture or webpage exceeds the screen window, the user has to either adjust the breadth of the file, picture or webpage, or horizontally move the horizontal scroll bar for viewing the exceeded field. Unfortunately, the conventional mouse wheel can be used for driving the vertical scroll bar only, and cannot be used for driving the horizontal scroll bar. Therefore, the user may feel inconvenient when desiring to horizontally move the frame.

In addition, in accordance with the fast development of the computer technology, there have been many computer assisted operation methods proposed for the users. Correspondingly, there are also lots of softwares provided for fast operations. For example, shortcut keys of the keyboard, mouse key plus roller wheel, and key combinations can be used for fast operating the software. When the user operates the mouse and the keyboard for controlling the software in this manner, he must use one hand to operate the mouse while using the other hand to operate the keyboard; or control one key with one finger while controlling another key with another finger; or control one key with one finger while controlling the roller wheel with another finger. Nevertheless, this manner requires the simultaneous participation of both hands, or at least two fingers of the user. For example, China Patent Publication No. CN101201717A discloses a related conventional technology. According to the conventional technology, the right button of the mouse is being pressed down by the middle finger of the user, and at the same time, the forefinger operates the roller wheel of the mouse, thus achieving a faster and more convenient horizontal scrolling control operation of the software window. However, this conventional technology requires that the forefinger must roll the roller wheel while the right button is pressed by the middle finger. Therefore, the operation of pressing the right button of the mouse may disable the predetermined function of the right button of the mouse.

Moreover, U.S. Pat. Nos. 6,700,564, 7,079,110, 7,187,358, 7,199,785, 7,205,977, 7,079,110, 7,187,385, 7,199,785, and 7,205,977 have proposed a tilt wheel for supporting the horizontal scroll operation of the software window. However, such an additional control approach increases the hardware cost of fabricating the mouse. Further, in operation, the tilt wheel repetitively tilts, and therefore its consecutive rolling capability stability is inferior to the ordinary mouse wheel.

### SUMMARY OF THE INVENTION

A primary objective of the present invention is to provide a method for switching operation functions of a PC mouse wheel, according to a present position of a cursor pointer of the PC mouse. According to the method, the user achieves more convenience by operating the PC mouse to execute more functions.

For achieving the foregoing objectives and others, the present invention provides a method for switching operation functions of a PC mouse wheel, according to a present position of a cursor pointer of the PC mouse. According to the method, a screen window or a software window is partitioned by a software into at least two sub-fields. Each of the sub-fields is correspondingly predetermined with a functional operation instruction of the PC mouse wheel. When the cursor pointer is moved into one of the sub-fields while the mouse wheel is operated, the functional operational instruction corresponding to the sub-field in which the cursor pointer is located is initiated for execution.

Further, when the cursor pointer is moved into one of the sub-fields, an operation instruction symbol is displayed on the screen window or the software window for reminding the functional operational instruction corresponding to the sub-field in which the cursor pointer is currently located.

Preferably, the mouse wheel is an up-down mouse wheel or a left-right tilt wheel of a PC mouse, or a vertical up-down scroll or a horizontal left-right scroll of a touchpad mouse.

According to an aspect of the present invention, the quantity and areas of the sub-fields of the screen window or software window are determined by the user.

According to another aspect of the present invention, the corresponding relationship between the sub-fields and the functional operation instructions can be determined by the user.

According to a further aspect of the present invention, the software is adapted for displaying an identifiable partitioning identification on the screen window or the software window, for partitioning the screen window or the software window into a plurality of sub-fields. The partitioning identification includes dots, solid lines, dashed lines, or circular lines, or the like, and can be determined by the user.

When the mouse is operated in accordance with the method of the present invention, the software is executed with a corresponding function according to the sub-filed in which the cursor pointer is located. The method includes the following steps:

Step 1: initiating a mouse filtering sub-program;

Step 2: the mouse filtering sub-program partitioning a full screen region into at least two sub-fields according to an instruction of a user, and assigning a serial code to each of the sub-fields;

Step 3: the mouse filtering sub-program instantly recording the sub-field in which a cursor pointer of the mouse is located, and capturing mouse wheel signals of the mouse, wherein when the mouse wheel is initiated, the mouse filtering sub-program transmits an execution instruction to a host process according to the sub-field in which the cursor pointer is located to execute the predetermined related mouse wheel functional operation instruction corresponding to the sub-field.

According to the present invention, the cursor pointer of the mouse is moved in different sub-fields which corresponding to different mouse wheel functions. When the cursor pointer is located in any of the different sub-fields, the software is initiated to execute a specific operation according to the sub-field in which the cursor pointer is located. In such a way, the operations of the user are simplified, so that the user can conveniently and consistently operate the mouse. Furthermore, the present invention allows the user to determine corresponding relationship between the mouse wheel signal of each sub-field and the corresponding execution of the specific operation of the software, so as to allow the user for more humanistically and more intuitively operating the mouse.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a structure of an ordinary mouse;

FIG. 2A is a schematic diagram illustrating two sub-fields partitioned from the screen (or a software window) according to an embodiment of the present invention;

FIG. 2B is a schematic diagram showing a short line displayed at an edge of the screen or the software window identifying the sub-fields according to an embodiment of the present invention;

FIG. 2C is a schematic diagram showing a dot displayed at an edge of the screen or the software window identifying the sub-fields according to an embodiment of the present invention;

FIG. 3A is a schematic diagram illustrating three sub-fields partitioned from the screen or the software window according to an embodiment of the present invention;

FIG. 3B illustrates an optional function menu popped out when the cursor pointer is located in a certain sub-field (B hereby);

FIG. 4 is a schematic diagram illustrating six sub-fields partitioned from the screen or the software window according to an embodiment of the present invention;

FIG. 5 is a flow chart illustrating a control method for executing a related operation with respect to the software;

FIG. 6 is a flow chart illustrating a procedure of partitioning the screen or the software window into the sub-fields and determining the operational instructions;

FIG. 7 is a flow chart illustrating another control method for executing a related operation with respect to the software; and

FIG. 8 is a flow chart illustrating a further control method for executing a related operation with respect to the software.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

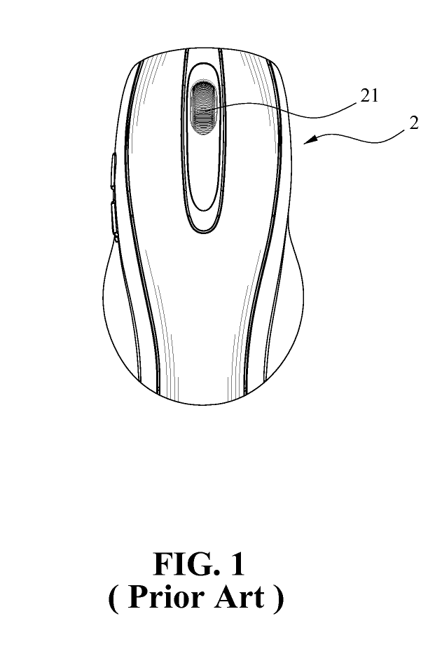

FIG. 1 is a schematic diagram illustrating a structure of an ordinary mouse. Typically, such a mouse 2 includes a mouse wheel 21 provided for being operated by a user. According to the present invention, the mouse wheel 21 is operated as an operational unit for partitioning the screen into a plurality of sub-fields and achieving a multi-functional operation.

### The First Embodiment

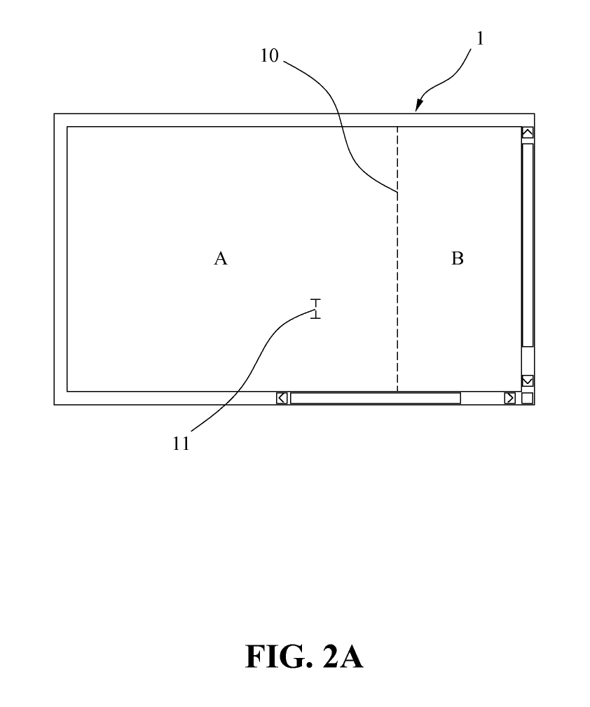

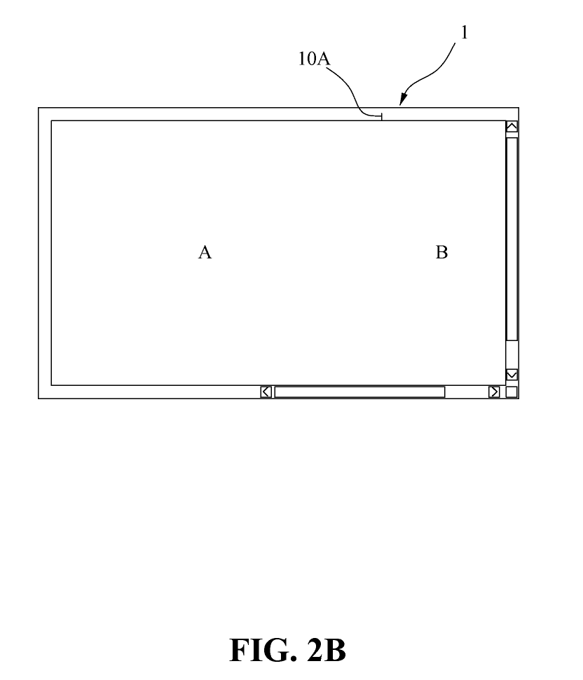

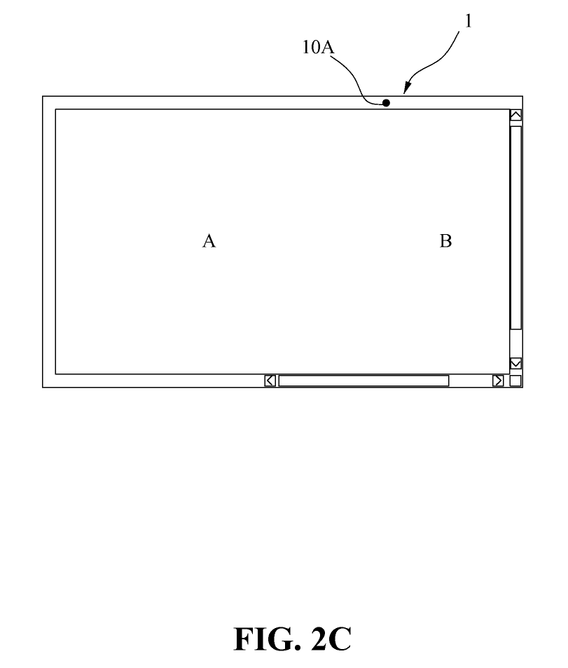

FIG. 2A is a schematic diagram illustrating two sub-fields partitioned from the screen (or a software window) according to an embodiment of the present invention. FIG. 2B is a schematic diagram showing a short line displayed at an edge of the screen or the software window identifying the sub-fields according to an embodiment of the present invention. FIG. 2C is a schematic diagram showing a dot displayed at an edge of the screen or the software window identifying the sub-fields according to an embodiment of the present invention.

Supposing that the software includes a built-in checklist of operational instructions related to the mouse wheel of the mouse. The software includes a mouse filtering sub-program. The mouse filtering sub-program is adapted for partitioning the screen window into a plurality of sub-fields. Referring to FIG. 2A, there is shown a partitioning line or symbol 10 partitioning the screen window 1 into two sub-fields. Although the partitioning line or symbol 10 is clearly shown in FIG. 2A, it should be noted that the partitioning line or symbol 10 can be either visible or invisible by naked eyes. If the partitioning line or symbol 10 is visible, it is preferred that the width of the partitioning line or symbol 10 can be determined by the user. The partitioning line or symbol 10 either vertically breakthroughs the screen window 1 or not, or horizontally breakthroughs the screen window 1 or not. The partitioning line or symbol 10 can be a solid line, a dashed line, a floating water mark, a reverse line, or a pattern mark. If the partitioning line or symbol 10s invisible, it is a suppositional line, which either vertically breakthroughs the screen window 1 or not, or horizontally breakthroughs the screen window 1 or not. In order to allow the user clearly identifying the position of the partitioned sub-fields, as shown in FIG. 2B, a partitioning symbol 10A is displayed at a vertical edge and/or a horizontal edge for identifying the partitioning position. The partitioning symbol 10A can be a short line as shown in FIG. 2B, or a dot as shown in FIG. 2C. The area of each of the sub-fields can also be determined by the user.

As shown in FIG. 2A, the screen window 1 is partitioned into a first sub-field A having a larger area and a second sub-field B having a smaller area. Each of the first sub-field A and the second sub-field B is correspondingly related to a mouse wheel functional operation instruction. The correlation therebetween can be determined by the user. For example, when a cursor pointer 11 of the mouse is located the first sub-field A, the operations of rolling the mouse wheel 21 up and down can be correspondingly correlated to the functional operation instructions of rolling up and down a presently displayed frame, respectively. When the cursor pointer 11 of the mouse is located the second sub-field B, an operation instruction symbol representing a horizontal scroll operation is displayed, and the operations of rolling the mouse wheel 21 up and down can be correspondingly correlated to the functional operation instructions of scrolling leftward and rightward the presently displayed frame, respectively.

### The Second Embodiment

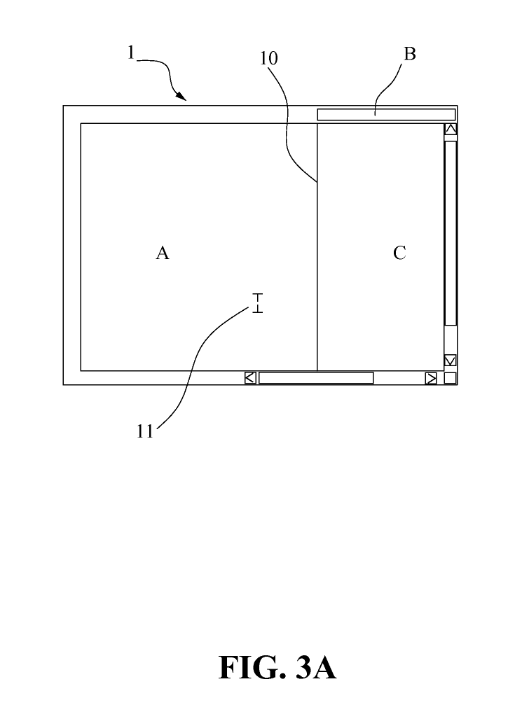

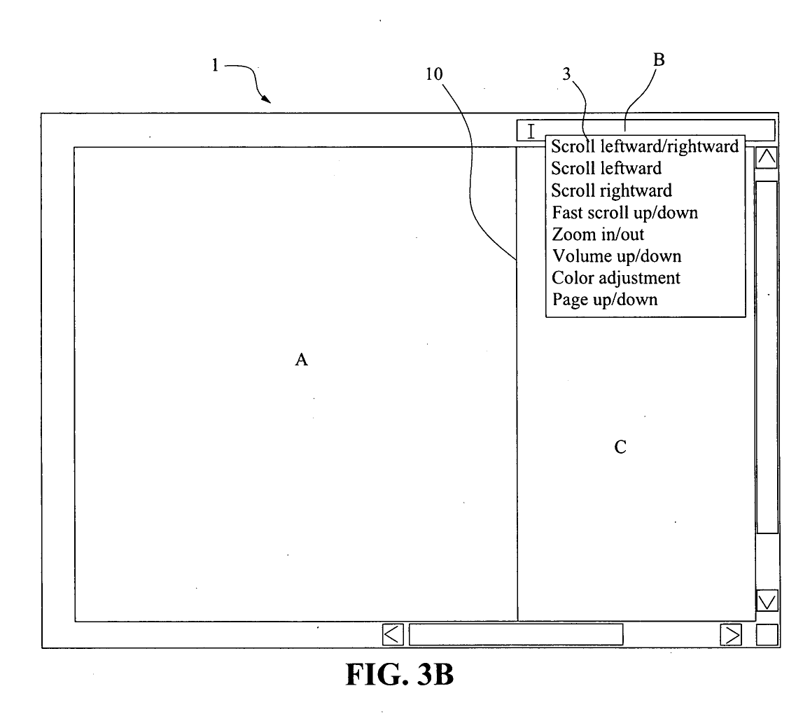

FIG. 3A is a schematic diagram illustrating three sub-fields partitioned from the screen or the software window according to an embodiment of the present invention. FIG. 3B illustrates an optional function menu popped out when the cursor pointer is located in a certain sub-field (B hereby).

Referring to FIGS. 3A and 3B, the screen window 1 is partitioned into a first sub-field A, a second sub-field B, and a third sub-field C. The first sub-field A corresponds to a predetermined mouse wheel functional operation instruction for controlling the screen window to vertically scroll up or down. The second sub-field B corresponds to a predetermined pop-up or pull-down option menu 3 at a position of a title bar of the software for allowing the user to select a mouse wheel functional operation instruction therefrom.

The mouse wheel functional operation instruction selected from the option menu 3 for example can be a mouse wheel functional operation instruction for controlling the screen window to horizontally scroll leftward, a mouse wheel functional operation instruction for controlling the screen window to horizontally scroll rightward, a mouse wheel functional operation instruction for controlling the screen window to zoom in or zoom out, a mouse wheel functional operation instruction for controlling an audio volume up or down, a mouse wheel functional operation instruction for controlling a color adjustment of the screen window, or a mouse wheel functional operation instruction for controlling the screen window to page up or down. The third sub-field C is predetermined with an execution instruction for executing the selected mouse wheel functional operation instruction.

When the cursor pointer 11 is moved into the first sub-field A, the screen window can be controlled to scroll up or down by rolling the mouse wheel forward or downward, respectively. When the cursor pointer 11 is moved into the second sub-field B, an option menu 3 is popped up or pulled down for the user to select. For example, supposing that the user selects the mouse wheel functional operation instruction for controlling the screen window to horizontally scroll leftward or rightward, the option menu 3 disappears. Then cursor pointer 11 is moved to the third sub-field C, in which the screen window can be controlled to scroll leftward or rightward by rolling the mouse wheel forward or downward, respectively. When the user desires to use an alternative mouse wheel function, he can direct the cursor pointer 11 back to the sub-field B to select a corresponding mouse wheel functional operation instruction from the option menu 3.

### The Third Embodiment

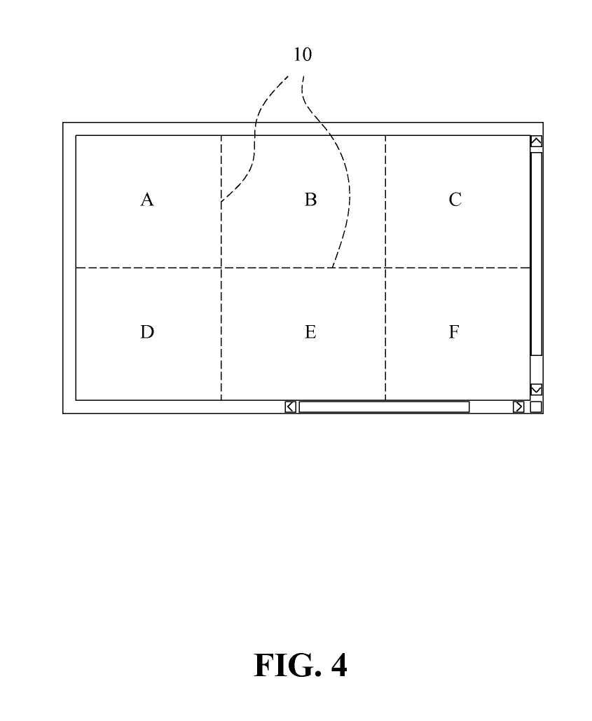

FIG. 4 is a schematic diagram illustrating six sub-fields partitioned from the screen or the software window according to an embodiment of the present invention. Referring to FIG. 4, the screen window or the software window is partitioned into six sub-fields A through F, each of which corresponding to a related mouse wheel functional operation instruction. For example, the user can determines to set the corresponding relationship as: when the cursor pointer 11 is moved into the first sub-field A, the screen window can be controlled to scroll up or down by rolling the mouse wheel 21 forward or backward; when the cursor pointer 11 is moved into the second sub-field B, an operation instruction symbol representing a horizontal scroll operation is displayed in the second sub-field B, and the screen window can be controlled to horizontally scroll leftward or rightward by rolling the mouse wheel 21 forward or backward; when the cursor pointer 11 is moved into the third sub-field C, an operation instruction symbol representing a fast scroll operation is displayed in the third sub-field C, and the screen window can be controlled for fast scrolling by rolling the mouse wheel 21 forward or backward; when the cursor pointer 11 is moved into the fourth sub-field D, an operation instruction symbol representing an audio volume adjustment operation is displayed in the fourth sub-field D, and the audio volume can be controlled up or down by rolling the mouse wheel 21 forward or backward; when the cursor pointer 11 is moved into the fifth sub-field E, an operation instruction symbol representing a color adjustment operation is displayed in the fifth sub-field E, and the color of the screen window can be adjusted to become brighter or darker by rolling the mouse wheel 21 forward or backward; and when the cursor pointer 11 is moved into the sixth sub-field F, an operation instruction symbol representing an paging operation is displayed in the sixth sub-field F, and the screen window can be paged up or down by rolling the mouse wheel 21 forward or backward.

It should be noted, the foregoing correlation is provided as an example for exemplifying the third embodiment of the present invention without restricting the present invention as such. In fact, the screen window can be partitioned into more or less sub-fields in accordance with the spirit of the present invention, and the correlation can be determined by the user as desired.

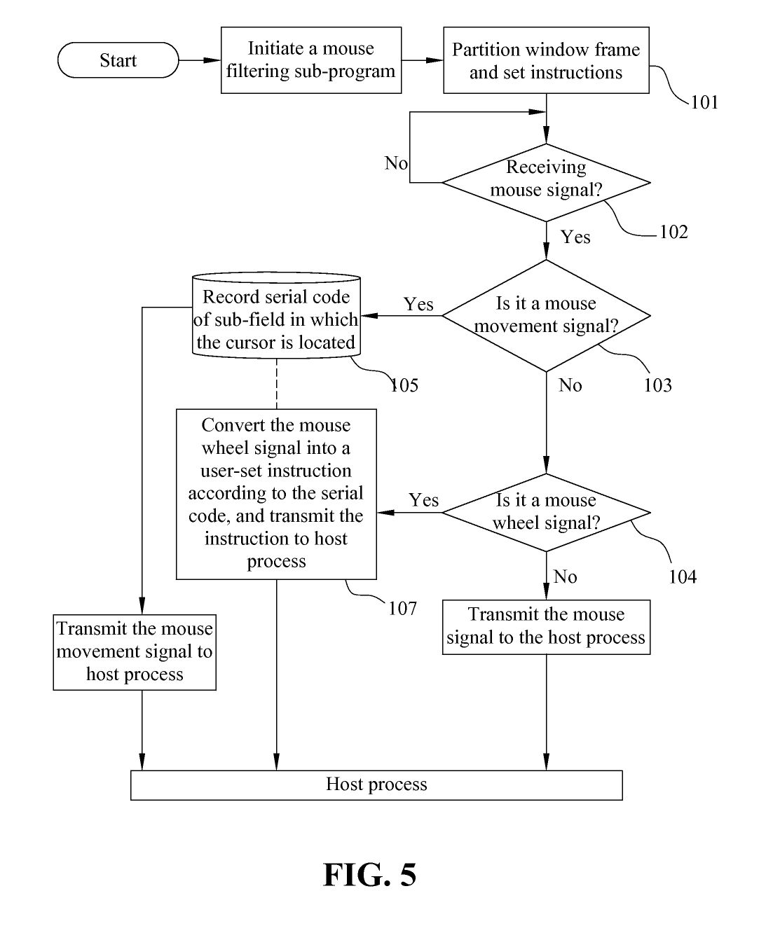

FIG. 5 is a flow chart illustrating a control method for executing a related operation with respect to the software. According to the method, a mouse filtering sub-program is started by a trigger key provided by a hardware, or a functional key or functional menu provided by a software, or a predetermined execution program. The mouse filtering sub-program includes the following steps:

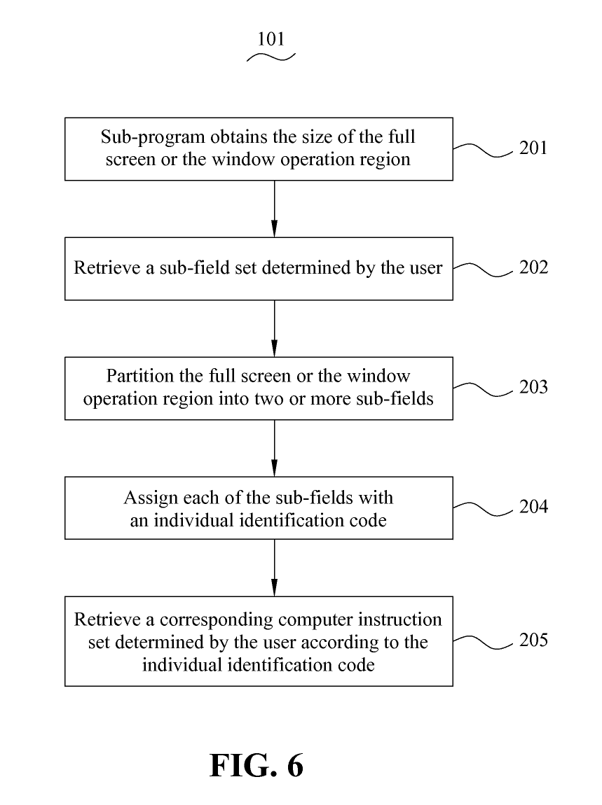

Step 101: partitioning the screen window and determining the operation instructions, details of which can be learnt by referring to FIG. 6 and the discussion below;

Step 102: entering a waiting status, in which when the mouse is operated, the mouse filtering sub-program starts to capture mouse signals including mouse button signals, mouse wheel signals, and mouse movement signals, until one of the mouse signals is captured;

Step 103: determining whether or not the captured mouse signal is a mouse movement signal, in which when the captured signal is determined to be a mouse movement signal, then a serial code of the sub-filed in which the cursor pointer is located is recorded, and when the captured signal is determined to be not a mouse movement signal, then the captured signal is further proceeded in step 104;

Step 104: determining whether or not the captured mouse signal is a mouse wheel forwarding signal or a mouse wheel backwarding signal, in which when the captured signal is determined to be not a mouse wheel forwarding signal or a mouse wheel backwarding signal, the captured signal is directly provided to the host process, and when the captured signal is determined to be a mouse wheel forwarding signal or a mouse wheel backwarding signal, then the captured signal is further proceeded in step 107;

Step 105: recording the serial code of the sub-field in which the cursor pointer is located, and subsequently providing the recorded serial code to the received mouse wheel signal for reference; and

Step 107: after receiving the mouse wheel signal, referring to the recorded serial code in step 105, and according to the serial code of the sub-field in which the cursor pointer is currently located, to convert the mouse wheel signal into an executing related operation instruction and provide the same to the host process.

FIG. 6 is a flow chart illustrating a procedure of partitioning the screen or the software window into the sub-fields and determining the operational instructions. As shown in FIG. 6, step 101 includes the following steps:

Step 201: obtaining the size of the full screen or the window operation region;

Step 202: retrieving a sub-field set determined by the user;

Step 203: partitioning the full screen or the window operation region into two or more sub-fields;

Step 204: assigning each of the sub-fields with an individual identification code; and

Step 205: retrieving a corresponding computer instruction set determined by the user according to the individual identification code.

It should be further noted that the mouse wheel functional operation instruction corresponding to each of the sub-fields can also be set as being started only when the mouse wheel is operated while simultaneously pressing the right button of the mouse or any key of the keyboard.

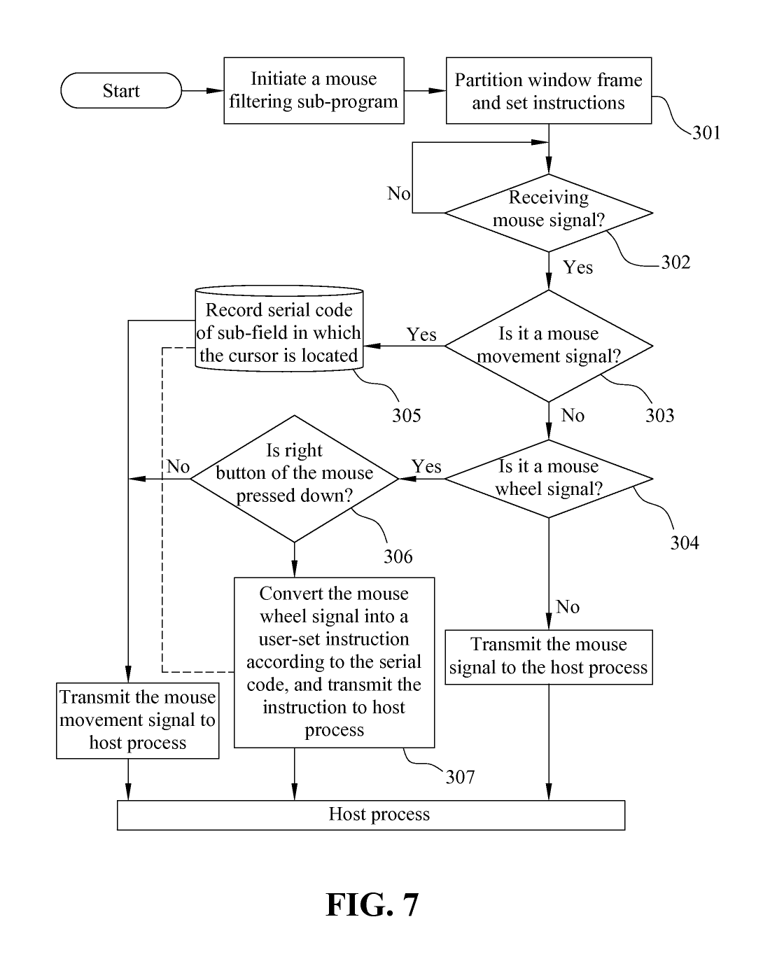

Facilitated with the cooperation of mouse wheel and the mouse right button, the software can be executed with the foregoing functions, details of which can be learnt by referring to FIG. 7. FIG. 7 is a flow chart illustrating another control method for executing a related operation with respect to the software. According to the method, a mouse filtering sub-program is started by a trigger key provided by a hardware, or a functional key or functional menu provided by a software, or a predetermined execution program. The mouse filtering sub-program includes the following steps:

Step 301: partitioning the screen window and determining the operation instructions, details of which can be learnt by referring to FIG. 6 and the discussion above;

Step 302: entering a waiting status, in which when the mouse is operated, the mouse filtering sub-program starts to capture mouse signals including mouse button signals, mouse wheel signals, and mouse movement signals, until one of the mouse signals is captured;

Step 303: determining whether or not the captured mouse signal is a mouse movement signal, in which when the captured signal is determined to be a mouse movement signal, then a serial code of the sub-filed in which the cursor pointer is located is recorded, and when the captured signal is determined to be not a mouse movement signal, then the captured signal is further proceeded in step 304;

Step 304: determining whether or not the captured mouse signal is a mouse wheel forwarding signal or a mouse wheel backwarding signal, in which when the captured signal is determined to be not a mouse wheel forwarding signal or a mouse wheel backwarding signal, the captured signal is directly provided to the host process, and when the captured signal is determined to be a mouse wheel forwarding signal or a mouse wheel backwarding signal, then the captured signal is further proceeded in step 306;

Step 305: recording the serial code of the sub-field in which the cursor pointer is located, and subsequently providing the recorded serial code to the received mouse wheel signal for reference;

Step 306: determining whether or not the right button of the mouse is being pressed down, in which when the right button of the mouse is determined as not pressed down, then the captured signal is provided to the host process, and when the right button of the mouse is determined as being pressed down, then the captured signal is further proceeded in step 307; and

Step 307: after receiving the mouse wheel signal and the right button signal, referring to the recorded serial code in step 305, and according to the serial code of the sub-field in which the cursor pointer is currently located, to convert the mouse wheel signal into an executing related operation instruction and provide the same to the host process.

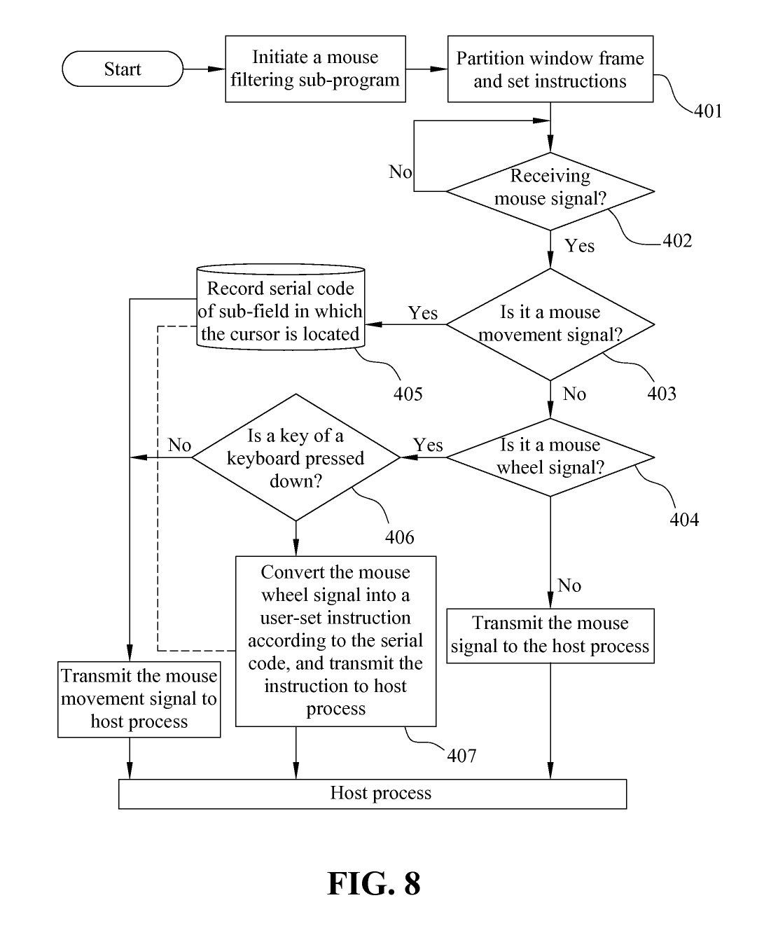

Facilitated with the cooperation of mouse wheel and the keyboard, the software can be executed with the foregoing functions, details of which can be learnt by referring to FIG. 8. FIG. 8 is a flow chart illustrating a further control method for executing a related operation with respect to the software. According to the method, a mouse filtering sub-program is started by a trigger key provided by a hardware, or a functional key or functional menu provided by a software, or a predetermined execution program. The mouse filtering sub-program includes the following steps:

Step 401: partitioning the screen window and determining the operation instructions, details of which can be learnt by referring to FIG. 6 and the discussion thereof above;

Step 402: entering a waiting status, in which when the mouse is operated, the mouse filtering sub-program starts to capture mouse signals including mouse button signals, mouse wheel signals, and mouse movement signals, until one of the mouse signals is captured;

Step 403: determining whether or not the captured mouse signal is a mouse movement signal, in which when the captured signal is determined to be a mouse movement signal, then a serial code of the sub-filed in which the cursor pointer is located is recorded, and when the captured signal is determined to be not a mouse movement signal, then the captured signal is further proceeded in step 404;

Step 404: determining whether or not the captured mouse signal is a mouse wheel forwarding signal or a mouse wheel backwarding signal, in which when the captured signal is determined to be not a mouse wheel forwarding signal or a mouse wheel backwarding signal, the captured signal is directly provided to the host process, and when the captured signal is determined to be a mouse wheel forwarding signal or a mouse wheel backwarding signal, then the captured signal is further proceeded in step 406;

Step 405: recording the serial code of the sub-field in which the cursor pointer is located, and subsequently providing the recorded serial code to the received mouse wheel signal for reference;

Step 406: determining whether or not a predetermined key of the keyboard is pressed down, in which when the predetermined key is determined as not pressed down, then the captured signal is provided to the host process, and when the predetermined key is determined as being pressed down, then the captured signal is further proceeded in step 407; and

Step 407: after receiving the mouse wheel signal and the predetermined key signal, referring to the recorded serial code in step 405, and according to the serial code of the sub-field in which the cursor pointer is currently located, to convert the mouse wheel signal into an executing related operation instruction and provide the same to the host process.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for operating a mouse wheel of a mouse of a computer according to a position of a cursor pointer of the mouse, comprising:
using a software to partition a screen frame or a software window frame into at least two sub-fields, each of the sub-fields corresponding to a predetermined related mouse wheel functional operation instruction,
wherein when a cursor pointer of the mouse is moved into one of the sub-fields, and while the mouse wheel is in operation, the predetermined related mouse wheel functional operation instruction corresponding to the sub-field in which the cursor pointer is instantly located is then initiated and executed.

2. The method according to claim 1, wherein when the cursor pointer of the mouse is moved into one of the sub-fields, an operation instruction symbol is automatically displayed on the screen frame or the software window frame for reminding the predetermined related mouse wheel functional operation instruction corresponding to the sub-field.

3. The method according to claim 1, wherein the mouse wheel is an up-down mouse wheel of a mouse.

4. The method according to claim 1, wherein the mouse wheel is a left-right tilt wheel of a mouse.

5. The method according to claim 1, wherein the mouse wheel is a vertical up-down scroll member of a touchpad mouse.

6. The method according to claim 1, wherein the mouse wheel is a horizontal left-right scroll member of a touchpad mouse.

7. The method according to claim 1, wherein the sub-fields are partitioned by one or more visible or invisible identification mark(s).

8. The method according to claim 7, wherein the identification mark(s) comprise(s) a dot, a solid line, a dashed line, or a circular symbol.

9. The method according to claim 1, wherein the predetermined related mouse wheel functional operation instruction comprises a functional operation instruction for controlling the window frame to horizontally scroll leftward and rightward.

10. The method according to claim 1, wherein the predetermined related mouse wheel functional operation instruction comprises a functional operation instruction for controlling the window frame to horizontally scroll leftward.

11. The method according to claim 1, wherein the predetermined related mouse wheel functional operation instruction comprises a functional operation instruction for controlling the window frame to horizontally scroll rightward.

12. The method according to claim 1, wherein the predetermined related mouse wheel functional operation instruction comprises a functional operation instruction for controlling the window frame to vertical fast scroll up and down.

13. The method according to claim 1, wherein the predetermined related mouse wheel functional operation instruction comprises a functional operation instruction for controlling the window frame to zoom in or zoom out.

14. The method according to claim 1, wherein the predetermined related mouse wheel functional operation instruction comprises a functional operation instruction for controlling an audio volume adjustment operation.

15. The method according to claim 1, wherein the predetermined related mouse wheel functional operation instruction comprises a functional operation instruction for controlling the window frame to page up or page down.

16. The method according to claim 1, wherein the predetermined related mouse wheel functional operation instruction comprises a functional operation instruction for controlling a color adjustment operation of the window frame.

17. The method according to claim 1, wherein when the cursor pointer is located in a sub-field, the predetermined related mouse wheel functional operation instruction corresponding to the sub-field is an instruction for controlling the window frame to vertically scroll up or down.

18. The method according to claim 1, wherein the software comprises the steps of:
Step 1: initiating a mouse filtering sub-program;
Step 2: the mouse filtering sub-program partitioning a full screen region into at least two sub-fields according to an instruction of a user, and assigning an individual serial code to each of the sub-fields; and
Step 3: the mouse filtering sub-program instantly recording the sub-field in which the cursor pointer of the mouse is located, and capturing mouse wheel signals of the mouse, wherein when the mouse wheel is initiated, the mouse filtering sub-program transmits an execution instruction to a host process according to the sub-field in which the cursor pointer is located to execute the predetermined related mouse wheel functional operation instruction corresponding to the sub-field.

19. The method according to claim 1, wherein the predetermined related mouse wheel functional operation instruction is selected by a user from a pop-up option menu.

20. The method according to claim 1, wherein when the mouse wheel of the mouse is in operation and a right button of the mouse is pressed down at the same time, the predetermined related mouse wheel functional operation instruction corresponding to the sub-field is executed.

21. The method according to claim 1, wherein when the mouse wheel of the mouse is in operation and a key of a keyboard is pressed down at the same time, the predetermined related mouse wheel functional operation instruction corresponding to the sub-field is executed.

22. A method for operating a mouse wheel of a mouse of a computer according to a position of a cursor pointer of the mouse, comprising:
using a software to partition a screen frame or a software window frame into:
a first sub-field, corresponding to a predetermined mouse wheel functional operation instruction for controlling the screen frame or the software window frame to vertically scroll up or down;
a second sub-field, corresponding to a predetermined pop-up option menu for allowing the user to select a mouse wheel functional operation instruction from the pop-up option menu; and
a third sub-field, corresponding to an execution instruction for executing the selected mouse wheel functional operation instruction;
wherein when a cursor pointer is moved into the first sub-field, the predetermined mouse wheel functional operation instruction for controlling the screen frame or the software window frame to vertically scroll up or down is initiated and executed;
when the cursor pointer is moved into the second sub-field, an option menu is popped up for the user to select a mouse wheel functional operation instruction from the pop-up option menu; and
when the cursor pointer is moved into the third sub-field, and when the user operates the mouse wheel of the mouse, the selected mouse wheel functional operation instruction is initiated and executed.

23. The method according to claim 22, wherein the option menu is popped up or pulled down from a position of a title bar of the software.
